(19) United States
(12) Patent Application Publication
(10) Pub. No.: US 2007/0297303 A1
(43) Pub. Date: Dec. 27, 2007

(54) Optical Pickup Control Circuit

(75) Inventors: Osamu YAMADA, Gunma-ken (JP); Hiroyuki SHIONO, Ota-city (JP)

Correspondence Address: HOGAN & HARTSON L.L.P., 1999 AVENUE OF THE STARS, SUITE 1400, LOS ANGELES, CA, 90067, US

(73) Assignee: SANYO ELECTRIC CO., LTD., Osaka (JP)

(21) Appl. No.: 11/846,407

(22) Filed: Aug. 28, 2007

Related U.S. Application Data
(63) Continuation of application No. 10/255,865, filed on Sep. 26, 2002, now abandoned.

(30) Foreign Application Priority Data
Sep. 28, 2001 (JP) 2001-300951

(51) Int. Cl. G11B 7/095

(52) U.S. Cl. 369/44.36

(57) ABSTRACT

In an optical disc playback device, focus and tracking balance amounts are automatically adjusted to specified amounts. An error rate from an error correction circuit for performing error correction of data played back from an optical disk using the optical pickup is then measured, and if the measurement results are a specified threshold value or higher it is determined that the optical disc being played is an inferior disk. The focus and tracking balance amounts are then adjusted to as to reduce the error rate to a minimum level.

### BACKGROUND OF THE INVENTION

1. Field Of The Invention

The present invention relates to optical pickup control circuit irradiation control for controlling irradiated light irradiated to an optical disc, for reading-in data stored on an optical disc.

2. Description Of The Related Art

Up to now, optical discs such as CDs and DVDs have spread widely, and optical disc reproduction devices exist for reading out data stored in these optical discs.

An optical disc is disc-shaped, and data is recorded by forming pits of differing length in a spiral shape on a signal recording surface. In an optical disc reproduction device, laser light is then irradiated to the optical disc and data is read by detecting pits based on reflected light. In order to perform this reading, it is necessary to focus the irradiated light on the optical disc surface, and also to perform tracking so that the irradiated light is always irradiated on the pits.

A focus servo system and a tracking servo system, for carrying out feedback control of a focus condition and a tracking condition of reflected light in response to the state of the reflected light are therefore provided in an optical disc reproduction device.

In this way appropriate focus control and tracking control can be performed, and optimum optical disc reproduction can be carried out.

However, there are situations where sufficient reproduction can not be performed, because of variations in sensitivity of light receiving elements of the optical pickup irradiating laser light on the optical disk, or poor optical disc quality.

### SUMMARY OF THE INVENTION

The object of the present invention is to provide an optical pickup for appropriately controlling irradiated light irradiated to an optical disc, for reading data stored on the optical disc.

The present invention generates an irradiation error signal representing a degree of irradiation error for irradiated light from light intensity conditions of light reflected from an optical disc, and controls irradiated light irradiated to the optical disc from the optical pickup in response to this irradiation error signal. In this way, irradiated light control can be carried out in the same way as under normal conditions. With the present invention, an error rate in read signal error correction is then detected, and if this error rate is a specified threshold or higher, irradiated light is controlled so that the error rate is reduced. As a result, even if an optical disc is of inferior quality this can be coped with and reading is made possible.

### BRIEF DESCRIPTION OF THE DRAWINGS

FIG. 1 is a block diagram showing an embodiment of the present invention.

FIG. 2A, FIG. 2B and FIG. 2C are drawings showing the principal of focus error detection using an astigmatism method.

FIG. 3 is a drawing showing a circuit structure for detecting and outputting a focus error signal using an output signal from a four segment detection sensor.

FIG. 4 is a drawing showing the circuit structure detecting and outputting a tracking error signal using an output signal from a four segment detection sensor.

FIG. 5A, FIG. 5B and FIG. 5C are drawings showing arrangement of a light spot on an optical disc for tracking error detection.

FIG. 6 is a drawing showing process flow for measuring error rate and adjusting balance in response to the measured amount.

FIG. 7 is a drawing for describing an ECC (error correction code) block.

### DESCRIPTION OF THE PREFERRED EMBODIMENTS

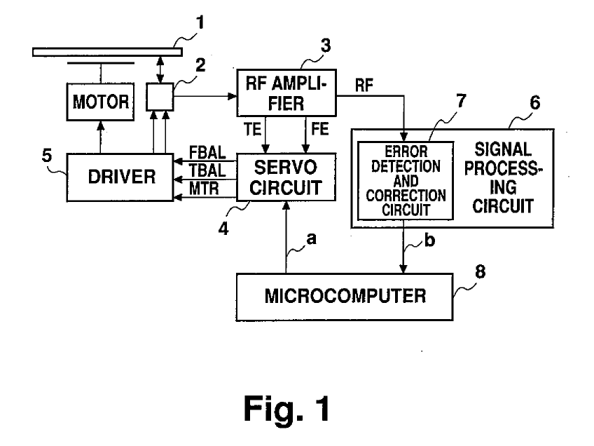

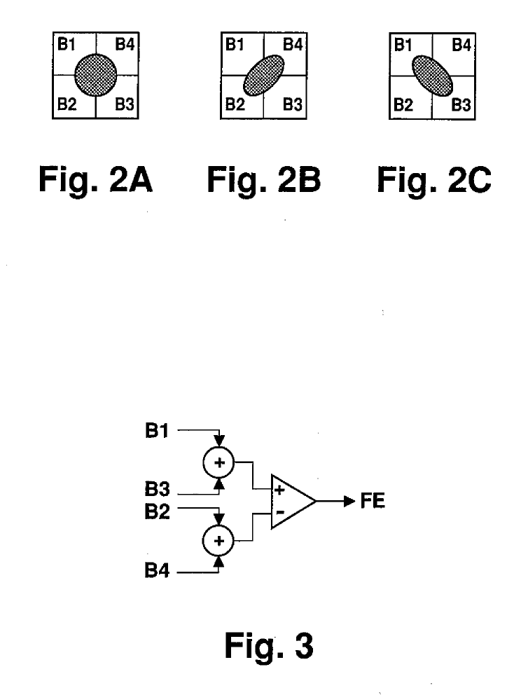

In FIG. 1, Reference numeral 1 represents an optical disk, on which a signal is recorded as data on a signal recording surface of the disc-shaped recording medium utilizing the fact that it is possible to form pits of differing length in a spiral shape. Reference numeral 2 is a optical pickup, having a laser light generating section for irradiating laser light to the optical disc 1, a cylindrical lens used in an objective lens for aligning a focus point of light reflected by the optical disc and in an astigmatism method, and a light receiving section formed as a four segment sensor for converting a beam focused by this lens into the signals B1-B4 shown in FIG. 2A-2C.

According to the principles of the astigmatism method, when the focal point is offset by the optical disc 1 approaching the objective lens, a beam has a shape as shown in FIG. 2B, and the levels of received light signals B2 and B4 from the four segment sensor become higher than the levels of signal B1 and B3. Also, when the focal point is offset by the optical disc moving away from the objective lens, the beam has a shape as shown in FIG. 2C and the levels of received light signals B1 and B3 become larger.

Reference numeral 3 is an RF amplifier, for outputting an RF signal, a focus error signal FE and a tracking error signal TE. Received light signals B1-B4 output from the optical pickup 2 are amplified, and the four signals B1-B4 are added together and output as the RF signal. FIG. 3 is a computation circuit for generating the focus error signal FE. The signals B1-B4 are operated on in the computation circuit shown in FIG. 3 to calculate ((B1+B3)−(B2+B4)), and the result of that calculation is output as the focus error signal FE.

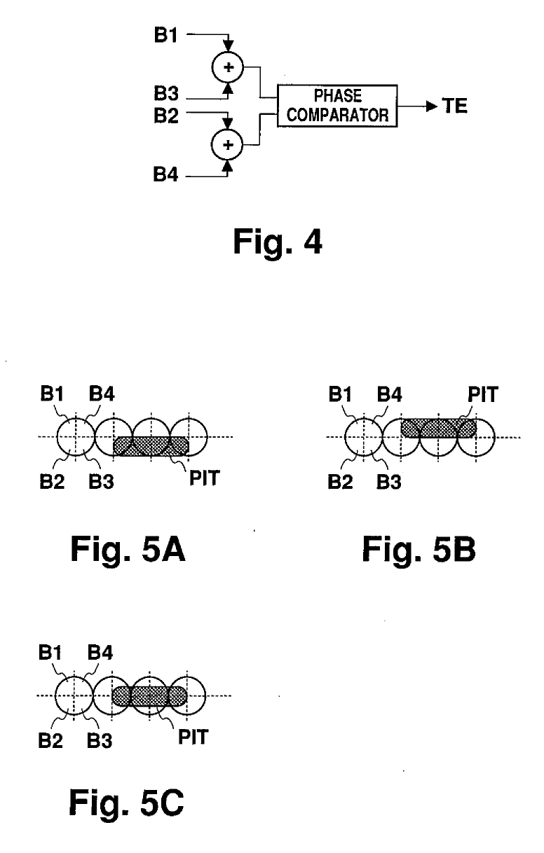

Further, FIG. 4 is a circuit for generating the tracking error signal TE. Signals B1-B4 are manipulated in the phase determining circuit of FIG. 4 to calculate (B1+B3) and (B2+B4), the calculated signals are subjected to phase comparison, and a tracking error signal TE is output from the RF amplifier 3 according to the comparison results. In more detail, as shown in FIG. 5A, when tracking slips so that the pits are at the lower side and the beam advances from left to right in the drawing, only output signals B2 and B3 from the four segment sensor react to received light, and so (B1+B3) including the initially reacting signal B3 is advanced in phase compared to (B2+B4), and the tracking error signal TE is output as a positive level. As shown in FIG. 5E, when tracking slips so that the pits are at the upper side and the beam advances from left to right in the drawing, only output signals B1 and B4 from the four segment sensor react to received light, and so (B2+B4) including the initially reacting signal B4 is advanced in phase compared to (B1+B3), and the tracking error signal TE is output as a negative level. As shown in FIG. 5C, when tracking is aligned, if the boundary of B1 and B4, and of B2 and B3, is position at the center of a pit signals B3 and B4 react at the same time, and so (B1+B3) and (B2+B4) are in phase, and the tracking error signal TE becomes a zero level.

Reference numeral 4 is a servo circuit, for judging levels of the focus error signal FE and the tracking error signal TE output from the RF amplifier 3, and outputting focus and tracking balance control signals FBAL and TEAL for controlling focus and tracking.

Reference numeral 5 is a driver for outputting focus and tracking actuator drive signals to the optical pickup 2 in response to the focus and tracking balance signals FBAL and TEAL.

Reference numeral 6 is a signal processing circuit for EFM subjecting the RF signal to EFM demodulation in the case of a CD, or subjecting the RF signal to EFM+(eight to sixteen modulation) demodulation in the case of a DVD (digital Versatile Disc). The demodulated signal is then subjected to error detection and correction by the error detection and correction circuit 7, and an error rate depending on the error correction results is measured. Reference numeral 8 is a microcomputer for judging the focus error signal FE, tracking error signal TE and error rate and outputting and setting data for focus and tracking balance amounts to the servo circuit 4.

First of all, balance amounts to make positive and negative direction signal levels for predetermined specified focus and tracking error signals zero levels from outside are set in the servo circuit 4 as initial settings when turning the power on.

In response to the initially set balance amounts for the focus and tracking error signals, focus and tracking balance signals FBAL and TBAL are output from the servo circuit 4. Once this is carried out, drive signals for the optical pickup 2 are output from the driver 5 in response to the focus and tracking balance signals EBAL and TBAL. Drive signals for the optical pickup 2 in an orthogonal direction and a radial direction with respect to the optical disc are then output from the driver 5 in response to the focus and tracking balance signals FBAL and TBAL.

Next, at the optical pickup 2, laser light is irradiated, a beam reflected by the optical disc 1 is received by a four segment sensor of a light receiving sections and signals B1-B4 are output from the four segment sensor in response to the received beam. The focus error signal FE and tracking error signal TE from the RF amplifier 3 are then output based on the signals B1-B4. In this way, using the optical pickup 2 a data signal is read from the optical disk 1 and that read signal is output.

After that, the signal read by the optical pickup 2 is amplified by the REF amplifier 3, and that amplified signal, namely the RF signal, and the focus error signal FE and the tracking error signal TE corresponding to the read signal, are output from the RF amplifier 3.

The level of the focus error signal FE is then detected by the servo circuit 4, and the focus balance signal FBAL is adjusted and output so as to make the focus error signal FE a zero level, as in FIG. 2A. In this way, if the focus error signal FE becomes a zero level, the adjustment and output is finished at an optimum point for the balance amount of the focus error signal. The focus error signal FE is thus coarsely controlled.

The level of the tracking error signal TE is then detected by the servo circuit 4, and the tracking balance signal TBAL is adjusted and output so as to make the tracking error signal TE a zero level. The adjustment and output is then finished with a value of the tracking balance signal to make the tracking error signal TE a zero level at the optimum point for tracking balance amount. The tracking error signal TE is thus coarsely controlled.

This completes initial adjustment of focus and tracking balance amounts, and audio or visual playback is then achieved through signal processing, in the signal processing circuit, of a playback signal from the optical disc based on the RF signal that constitutes a data signal output from the RF amplifier 3 based on signals B1-B4, while maintaining the optimum points of the focus error signal FE and the tracking error signal TE through fine adjustment of the focus error signal FE and the tracking error signal TE.

The pits can be determined according to standards, and have any one of nine lengths, from 3 to 11, with 3 being the shortest.

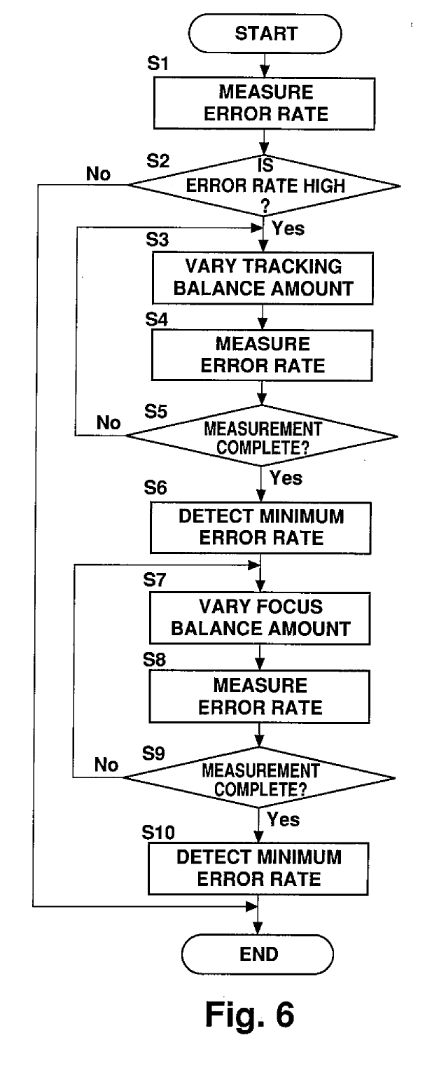

It is possible to obtain optimum points for balance amounts for both focus and tracking through adjustment. With this embodiment, balance amounts are adjusted further. This will be described using the flowchart of FIG. 6.

First of all, the signal processing circuit 6 demodulates the RF signal, that demodulated signal is subjected to error detection and correction by the error detection and correction circuit 7, and the error rate resulting from the error correction is measured (S1).

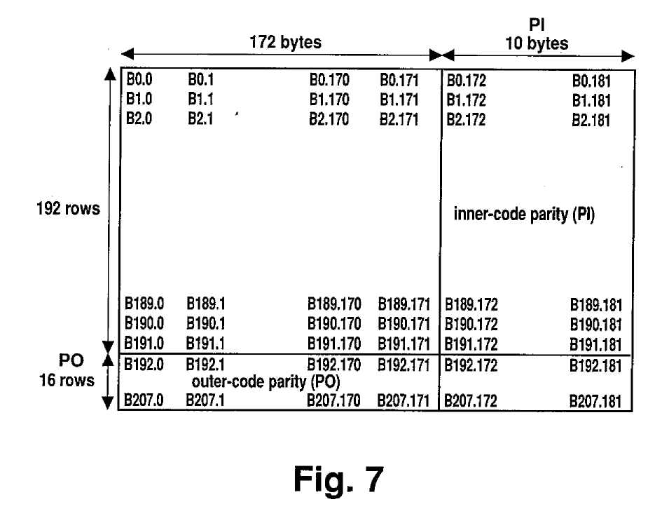

Calculation of the error rate will now be described. FIG. 7 is one ECC (error correcting code) block conforming to the DVD standard.

First of all, error detection and correction is performed on the block of the first column, using row symbol parity (PI), and a block error rate number for the first row is calculated using an arithmetic expression. Continuing on, the block error rate number for the second row is then calculated. In this way respective row data error correction is executed according to respective row symbol parity (PI), and error correction numbers are calculated corresponding to the respective row symbol parity (PI). Each calculated error rate is stored in a register inside the error detection and correction circuit 7, and once error rates have been calculated for all row blocks, the respective error rates are finally read out from all of the registers, a sum of the row data error correction numbers is calculated by the error detection and correction circuit 7, and this is stored in a register inside an interface to the microcomputer as an overall error rate.

Next, the microcomputer 8 designates an address of an interface register for the error detection and correction circuit 7, and an error rate is read out from this register and compared with a specified threshold. If the error rate is equal to or greater than the specified threshold, it is then judged that the optical disk being replayed is inferior, or that the characteristics of the optical pickup are poor, and processing advances (S2).

A specified tracking balance amount, being a limit range (traverse level) that a tracking servo can follow, is set in the microcomputer 8, and this value is transferred from the microcomputer 8 to the servo circuit 4 (S3). In the servo circuit 4, a tracking loop is forcibly set moving away from an optimum point according to this tracking balance amount.

Error detection and correction is carried out with the tracking balance amount set in step S3, and the error rate is measured. Error rate is then transferred to the microcomputer 8 as an error rate relative to a specified value of the tracking balance amount and stored in memory of the microcomputer 8 (S4).

After storing in memory, it is determined whether error rate has been measured for a plurality of tracking balance values, and processing advances if it is determined that measurement is complete. On the other hand, if measurement of error rate for a plurality of tracking balance amount values is not complete, processing returns to steps S3 and S4, and processing continues a number of times. In this way, a tracking loop is forcibly set in response to a plurality of tracking balance amounts, error rate is measured each time this is done, and the results are stored in the memory of then microcomputer 8 (S5).

If all measurement is complete, the microcomputer 8 detects the lowest error rate from amongst the error rates stored in memory, reads out the tracking balance amount for when the error rate is lowest and sets that tracking balance amount in the servo circuit 4 as a new optimum value for tracking balance amount. In this way, the tracking balance amount becomes a value that minimizes the error rate, and setting of tracking balance amount is complete (S6).

A specified focus balance amount, being a limit range (S-character level) that a focus servo can follow, is set in the microcomputer 8, and this value is transferred from the microcomputer B to the servo circuit 4 (S7). In the servo circuit 4, a focus loop is forcibly set moving away from an optimum point according to this focus balance amount.

Error detection and correction is carried out with the focus balance amount set in step S7, and the error rate is measured. Error rate is then transferred to the microcomputer 8 as an error rate relative to a specified value of the focus balance amount and stored in memory of the microcomputer 8 (S8).

After storing in memory, it is determined whether error rate has been measured for a plurality of focus balance values, and processing advances if it is determined that measurement is complete. On the other hand, if measurement of error rate for a plurality of focus balance amount values is not complete, processing returns to steps S7 and S8, and processing continues a number of times. In this way, a focus loop is forcibly set in response to a plurality of focus balance amounts, error rate is measured each time this is done, and the results are stored in the memory of the microcomputer 8 (S9).

If all measurement is complete, the microcomputer 8 detects the lowest error rate from amongst the error rates stored in memory, reads out the focus balance amount for when the error rate is lowest, makes that focus balance amount a new optimum focus balance amount and sets that focus balance amount in the servo circuit 4. In this way, the focus balance amount becomes a value where the error rate becomes minimum, and setting of focus balance amount is complete

In this way, setting of focus and tracking amounts with the lowest error rates is carried out, and it is possible to perform optical disk playback with improved playability.

On the other hand, when the detected error rate is less than the specified threshold value in step S2, it is determined that playback is satisfactory with conventional tracking and focus balance amount setting, processing terminates without adjustment of focus and tracking balance amounts originally set in the servo circuit 4 and playback begins.

In this manner, focus and tracking are carried out so that the focus error signal FE and the tracking error signal TE having conventional servo adjustment become substantially a zero level, further error detection and correction is carried out by the error detection and correction circuit 7, the measured error rate is judged through comparison with a predetermined specified threshold value, balance amounts are changed a number of times within a range of focus balance amount and tracking balance amount the servo can follow, and error rates are measured for the respectively changed balance amounts. Balance amounts for when the measured error rate is less than the specified threshold, and when error rate is minimum, are set in the servo 4, and optical disk playback is carried out.

With the embodiment of the invention, initially tracking balance amount is varied, error rate is measured and tracking balance amount is optimally adjusted, but it is also possible to carry out optimal adjustment of focus balance amount first.

Also with the embodiment, error rate is measured and both tracking and focus balance are adjusted, but it is also possible to only adjust one of either focus balance or tracking balance.

Further, with the embodiment, tracking and focus balance amount are varied a specified number of times and error rate is measured, but it is also possible, if a changed balance amount has an error rate less than a specified threshold value, to make the balance amount at that time the optimum amount and advance to the next processing step.

The specified threshold for error rate is a value predetermined based on an error rate obtained by playing back a plurality of optical discs where pit accuracy reaches a level defined in the optical disc standard, and inferior optical discs that do not reach that level.

In the description above, by simply carrying out automatic adjustment to adjust focus and tracking balance amounts for only original focus and tracking error signals, it is possible to prevent situations where there is reduction in playability due to inferior optical discs or variation in optical pickup characteristics to an extent that playback can not be performed, and where there is a lot of block noise in the reproduced image even when playback is possible, and playability can therefore be improved.

According to the present invention, if an error rate determined by the error correction circuit is greater than a specified threshold after adjustment of focus and tracking balance amounts, it is determined that an optical disk is of poor quality, and focus and tracking balance amounts are readjusted so that the error rate becomes a minimum value and the optical disk is played back. It is therefore possible to reliably improve playability of inferior discs.

It is also possible to bring about improvement in playability of optical discs without additional new circuitry, because error rate output from an error correction circuit is measured and focus and tracking balance amounts are determined to optimum points.

1-9. (canceled)

10. An optical pickup control circuit for controlling irradiated light irradiated to an optical disc, for read data recorded on the optical disc, comprising:
an irradiation error signal generating circuit for generating an irradiation error signal representing a degree of irradiation error for irradiated light from a light amount condition of light reflected from the optical disc;
a servo circuit for generating balance signals for controlling irradiated light irradiated to the optical disc from the optical pickup in response to the irradiation error signal;
an error correction circuit for carrying out error correction for a read signal obtained based on the light reflected from the optical disk and detecting an error rate for error correction;
a signal processing circuit for demodulating the read signal to obtain a demodulate signal; and
a servo control circuit for changing balance signals used by the servo circuit on the basis of the error rate of the demodulate signal so that the error rate is made smaller, in the event that the error rate detected in the error correction circuit is a specified threshold value or higher;
wherein the error correction circuit carries out error correction for the demodulate signal after the demodulate signal is obtained by the signal processing circuit; and
wherein the irradiation error signal is a signal representing a degree of irradiated light focus error, and the balance signals are signals for controlling focus of the optical pickup.

11. The optical pickup control circuit of claim 10, wherein:
the servo control circuit sequentially changes balance signals, error rates detected at that time by the error correction circuit are compared, and a balance signal giving a minimum error rate is used.

12. The optical pickup control circuit of claim 11, wherein:
the servo circuit changes the balance signals within a range that can be followed by the irradiation control for the optical pickup.

13. The optical pickup control circuit of claim 10, wherein:
the servo control circuit sequentially changes balance signals, and a balance signal of the balance signals, having a error rate detected at that time by the error correction circuit that is less than the threshold value, is used.

14. The optical pickup control circuit of claim 13, wherein:
the servo circuit changes the balance signals within a range that can be followed by the irradiation control for the optical pickup.

15. An optical pickup control circuit for controlling irradiated light irradiated to an optical disc, for read data recorded on the optical disc, comprising:
an irradiation error signal generating circuit for generating an irradiation error signal representing a degree of irradiation error for irradiated light from a light amount condition of light reflected from the optical disc;
a servo circuit for generating balance signals for controlling irradiated light irradiated to the optical disc from the optical pickup in response to the irradiation error signal;
an error correction circuit for carrying out error correction for a read signal obtained based on the light reflected from the optical disk and detecting an error rate for error correction;
a signal processing circuit for demodulating the read signal to obtain a demodulate signal; and
a servo control circuit for changing balance signals used by the servo circuit on the basis of the error rate of the demodulate signal so that the error rate is made smaller, in the event that the error rate detected in the error correction circuit is a specified threshold value or higher;
wherein the error correction circuit carries out error correction for the demodulate signal after the demodulate signal is obtained by the signal processing circuit; and
wherein the irradiation error signal is a signal representing a degree of irradiated light tracking error, and the balance signals are signals for controlling tracking of the optical pickup.

16. The optical pickup control circuit of claim 10, wherein:
the irradiation error signal includes both a signal representing degree of irradiated light focus error and a signal representing degree of irradiated light tracking error; and
the balance signals include both a signal for controlling focus of the optical pickup and a signal for controlling tracking of the optical pickup.

17. The optical pickup control circuit of claim 16, wherein:
the servo control circuit first sequentially changes balance signals of either one of focus or tracking, compares error rates for either focus or tracking detected at that time by the error correction circuit, and determines a balance signal for either focus or tracking giving a minimum error rate, and subsequently, sequentially changes balance signals of the other one of focus or tracking, compares error rates for the other one of focus or tracking detected at that time by the error correction circuit, and determines a balance signal for the other of focus or tracking giving a minimum error rated.

18. The optical pickup control circuit of claim 15, wherein:
the servo control circuit sequentially changes balance signals, error rates detected at that time by the error correction circuit are compared, and a balance signal giving a minimum error rate is used.

19. The optical pickup control circuit of claim 18, wherein:
the servo circuit changes the balance signals within a range that can be followed by the irradiation control for the optical pickup.

20. The optical pickup control circuit of claim 15, wherein:
the servo control circuit sequentially changes balance signals, and a balance signal of the balance signals, having a error rate detected at that time by the error correction circuit that is less than the threshold value, is used.

21. The optical pickup control circuit of claim 20, wherein:
the servo circuit changes the balance signals within a range that can be followed by the irradiation control for the optical pickup.

22. The optical pickup control circuit of claim 15, wherein:
the irradiation error signal includes both a signal representing degree of irradiated light focus error and a signal representing degree of irradiated light tracking error; and
the balance signals include both a signal for controlling focus of the optical pickup and a signal for controlling tracking of the optical pickup.

23. The optical pickup control circuit of claim 22, wherein:
the servo control circuit first sequentially changes balance signals of either one of focus or tracking, compares error rates for either focus or tracking detected at that time by the error correction circuit, and determines a balance signal for either focus or tracking giving a minimum error rate, and subsequently, sequentially changes balance signals of the other one of focus or tracking, compares error rates for the other one of focus or tracking detected at that time by the error correction circuit, and determines a balance signal for the other of focus or tracking giving a minimum error rated.
